(19) United States
(12) Patent Application Publication
(10) Pub. No.: US 2001/0034615 A1
(43) Pub. Date: Oct. 25, 2001

(54) Apparatus for and method of assessing, monitoring, and reporting on behavioral health disorders

(76) Inventors: Gregg Wilkinson, Nashville, TN (US); David Furse, Nashville, TN (US); Stephen Faris, Brentwood, TN (US); Tammy Gibbs, Franklin, TN (US); Carma Roetcisoender, Nashville, TN (US)

Correspondence Address: DICKSTEIN SHAPIRO MORIN & OSHINSKY LLP, Eric Oliver, 2101 L Street NW, Washington, DC, 20037-1526, US

(21) Appl. No.: 09/805,910

(22) Filed: Mar. 15, 2001

Related U.S. Application Data
(60) Provisional application No. 60/189,494, filed on Mar. 15, 2000.
(60) Provisional application No. 60/239,906, filed on Oct. 13, 2000.
(60) Provisional application No. 60/259,570, filed on Jan. 4, 2001.

(51) Int. Cl. G06F 17/60

(52) U.S. Cl. 705/2

(57) ABSTRACT

An apparatus (and corresponding method) is provided for assisting consumers in obtaining personalized medical information and services, such as health services for behavioral health disorders and learning difficulties, in accordance with a preferred embodiment of the invention. The apparatus in accordance with a preferred embodiment of the invention an initial assessment server and monitor server that combines patient medical and family history reporting with assessment, scoring and reporting, diagnosis support, treatment planning, outcome reporting, and other useful information in an integrated online system. Standardized input and data formats may be used to ease exchange of patient data between medical databases and resources. The system monitors, preferably using technology such as artificial intelligence, user inputs and data exchange to constantly improve performance. With the system, referrals can easily be made to other professionals involved in treatment. Multiple providers can thus form a “Care Team” having simultaneous access to patient data to facilitate collaboration among the providers. The system may adapt its tools and options based on the type of professional directing the assessment, diagnosis, treatment, etc.

This application claims priority to U.S. Provisional Application No. 60/189,494, entitled, “METHOD OF AND APPARATUS FOR BEHAVIORAL HEALTH ASSESSMENT,” filed Mar. 15, 2000, U.S. Provisional Application No. 60/239,906, entitled, “METHOD OF AND APPARATUS FORASSESSMENT AND MONITORING,” filed Oct. 13, 2000, and U.S. Provisional Application No. 60/259,570 (Attorney Docket No. H2100.0003/P003), entitled, “INTEGRATED REPORT WRITER (AND METHOD OF USING THE SAME),” filed Jan. 4, 2001, which are all hereby incorporated by reference in their entireties.

### BACKGROUND

The different types and quantities of medical resources available on the Internet have increased rapidly in recent years. Many online information sources currently exist from which medical consumers may obtain a wealth of data ranging from general medical topics to very specific diagnosis and treatment information. For example, using the Internet, medical consumers may obtain general information concerning basic types of medical problems, more specific guidance for investigating symptoms of particular disorders or diseases, detailed instructions for conducting self-evaluations or self-diagnosis, and receive a referral to a medical specialist.

Although a wide variety of medical resources are available from Internet sources, very little personalized information is passed between supplier and consumer. For example, while a medical consumer may obtain detailed descriptions of the symptoms for a particular disorder, collateral information concerning developmental factors or the patient's personal medical history may not be available or considered, possibly resulting in a mis-diagnosis or a failed diagnosis. Unless such personalized medical information is considered, access to distributed medical resources may be of only limited use. Thus, an interactive system, in which the medical consumer and medical resource supplier exchange patient information, is needed to more effectively navigate the large volume of Internet medical information.

More important to the dissemination of relevant medical information is the integration of various types of medical resources. Information traditionally available over the Internet is notoriously fragmented and piecemeal. In order to investigate a single medical question, medical consumers often must visit many different Web sites. For instance, descriptions of symptoms may be available at one Web location, co-occurring disorders may be available at another, and treatment planning at a third location.

It is also highly unlikely that distributed resources on the Internet share any information, so that the process of integration, or combining the gathered medical data with data from other resources and with the personalized patient information, is left to the medical consumer. Integrating technical medical data is a cumbersome process for many medical consumers, and errors or omissions in the integration process itself are the probable result. Therefore, there is a strong desire and need for an integrated, interactive system for exchanging medical information between a medical information consumer and supplier(s), such that personalized medical information may be included in any assessment or diagnosis and various types of medical information, may be combined into an integrated system of online diagnosis and treatment support, and may be presented in an organized fashion to document the assessment procedures performed.

### SUMMARY

An apparatus (and corresponding method) is provided for assisting consumers in obtaining personalized medical information and services, such as health services for behavioral health disorders and learning difficulties, in accordance with a preferred embodiment of the invention. The apparatus in accordance with a preferred embodiment of the invention an initial assessment server and monitor server that combines patient medical and family history reporting with assessment, scoring and reporting, diagnosis support, treatment planning, outcome reporting, and other useful information in an integrated online system. Standardized input and data formats may be used to ease exchange of patient data between medical databases and resources. The system monitors, preferably using technology such as artificial intelligence, user inputs and data exchange to constantly improve performance. With the system, referrals can easily be made to other professionals involved in treatment. Multiple providers can thus form a “Care Team” having simultaneous access to patient data to facilitate collaboration among the providers. The system may adapt its tools and options based on the type of professional directing the assessment, diagnosis, treatment, etc.

The system provides interactive data exchange to obtain patient personal information, including, for example, medical history, family history, school history, and developmental factors, which are combined into one of more Records (referred to herein as a “Behavioral Health Record (BHR)”). Contextual patient information may be obtained in an iterative fashion, including, for example, attitude and behavior patterns, academic performance and effort, and social interaction, which can be combined into one or more Scales (referred to herein, for example, as a “Child Functioning Scale (CFS))”). Gathered information can then be compared to one or more standard (or custom) rating scales for specific disorders, such as depression, anxiety, and hyperactivity, or to rating scales covering multiple disorders, such as attention-deficit/hyperactivity disorder (ADHD). Information gathering may be repeated as necessary to support diagnosis and treatment. The system then provides textual and graphical summaries of the gathered information, which can be combined with supporting raw data in a single hierarchical output. The output may also include customized forms to guide an interview with the patient, for example by a treating physician, to facilitate diagnosis. To facilitate patient tracking, a monitoring system is provided in accordance with a preferred embodiment of the invention. The monitor tool provides interested parties such as physicians, psychologists, psychiatrists, and parents the means to efficiently and effectively choose interventions, analyze the effectiveness, and adjust treatment as necessary. The clinicians are also provided with technology to collaborate on-line, and the ability to simultaneously view and modify central patient data records. The data records may be maintained over time (i.e., “longitudinally”) so that effects over time are easily studied.

In accordance with a preferred embodiment of the invention, an integrated report writer is provided to interface with the system to gain access to all information gathered by the system and to present all (or portions) of the information in an organized format that fully documents the assessment procedures.

### BRIEF DESCRIPTION OF THE DRAWINGS

FIG. 1 depicts an exemplary system architecture in accordance with a preferred embodiment of the invention;

FIG. 2 illustrates the operational flow of an exemplary method in accordance with a preferred embodiment of the invention;

FIGS. 3a, 3b, and 3c collectively illustrate the operational flow of an exemplary commercial implementation of a preferred embodiment of the invention; and

FIGS. 4 and 5 illustrate operational flow of an exemplary commercial implementation of a preferred embodiment of the invention.

### DETAILED DESCRIPTION OF PREFERRED EMBODIMENTS

Preferred embodiments and applications of the invention will now be described herein. Other embodiments may be realized and structural or logical changes may be made to the disclosed embodiments without departing from the spirit or scope of the invention. Although the invention is particularly described as applied to assessment, treatment planning, monitoring, and reporting of behavioral health disorders and learning difficulties, particularly Attention Deficit Hyperactivity Disorder (ADHD), it should be readily apparent that the invention may be embodied in any type of medical diagnosis or other treatment planning mechanism that lends itself to exchange of information related to behavioral health issues.

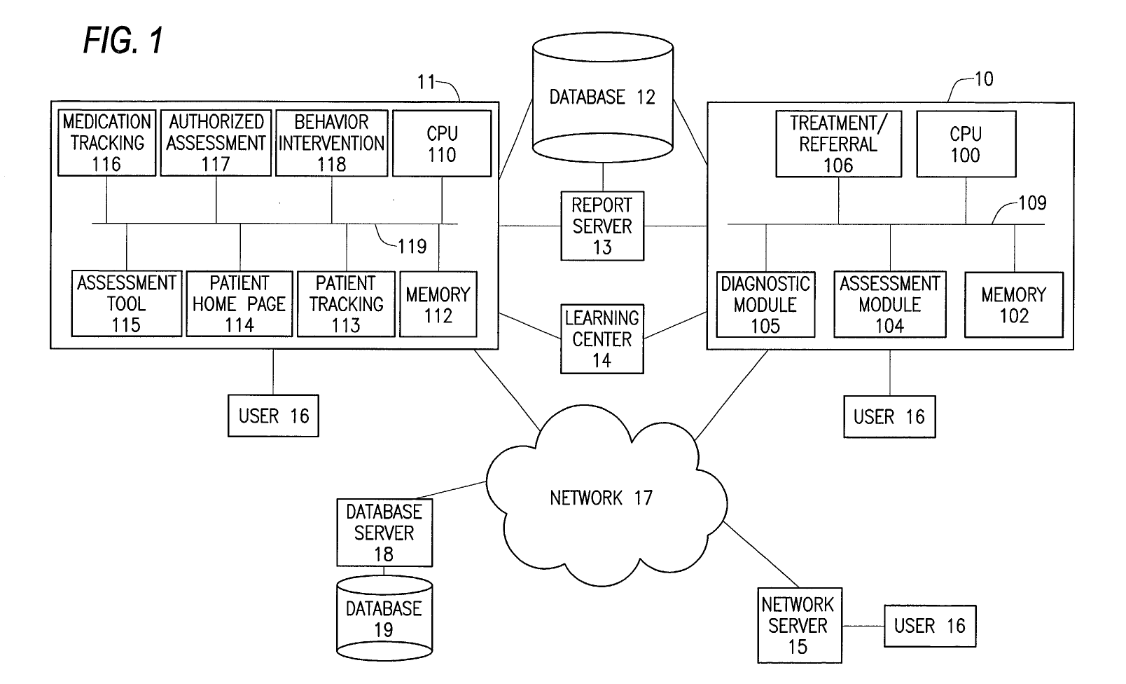

An exemplary system architecture in accordance with a preferred embodiment of the invention is illustrated in FIG. 1. The exemplary system architecture may be used to effectuate any one or more aspects of the assessment, monitoring, reporting, or other operations described in (and apparent from) the specific embodiments, implementations, and illustrations provided herein.

Some of the many system components that may be employed in the architecture include: one or more initial assessment servers (symbolically depicted as “IA server 10”); one or more monitor servers (symbolically depicted as “MON server 11”); one or more database units (symbolically depicted as “database 12”); one or more report writing servers (symbolically depicted as “report server 13”); one or more informational servers (symbolically depicted as “learning center server 14”); one or more remote database units (symbolically depicted as “database 19”); one or more networks (symbolically depicted as “network 17”); and one or more users (symbolically depicted as “user or user interface 16”), as will be described in more detail below.

In accordance with a preferred embodiment, IA server 10 may include one or more central processing units (CPUs) symbolically represented by CPU 100 used to provide processing of input/output data between IA server 10, database 12, report server 13, learning center server 14, MON server 11, user interface 16, and/or network 17, and among the different modules (all connected together via system bus 109) within IA server 10. CPU 100, which may be any known processor or processor-based subsystem, typically executes one or more executable instructions or programs stored in the one or more (local or remote) memory devices (or other articles of manufacture) symbolically represented as memory module 102. Individual control modules (e.g., assessment module 104, diagnostic module 105, treatment/referral module 106, etc.) may be provided to control processing of the initial assessment operations described in (or apparent from) the instant disclosure, as will be described in detail below. The individual control modules may themselves be processors or processor-based subsystem executing one or more executable programs (locally or remotely) stored in a memory component (or other article of manufacture).

In accordance with a preferred embodiment, MON server 11 may incorporate the same, similar, or different structure as IA server 10. MON server 11, for example, may similarly include one or more central processing units (CPUs) symbolically represented by CPU 110 used to provide processing of input/output data between MON server 11, database 12, report server 13, learning center server 14, IA server 10, user interface 16, and/or network 17, and among the different modules (all connected together via system bus 119) within MON server 110. CPU 110, which may also be any known processor or processor-based subsystem, typically executes one or more executable instructions or programs stored in the one or more (local or remote) memory devices (or other articles of manufacture) symbolically represented as memory module 112. Individual control modules (e.g., patient tracking module 113, patient home page generator 114, assessment tool module 115, medication tracking module 116, etc.) may be provided to control processing of the monitoring operations described in (or apparent from) the instant disclosure, as will be described in detail below. The individual control modules may themselves be processors or processor-based subsystem executing one or more executable programs (locally or remotely) stored in a memory component (or other article of manufacture).

User interface 16 may include one or more display devices (e.g., CRT, LCD, or other known displays) or other output devices (e.g., printer, etc.), and one or more input devices (e.g., keyboard, mouse, stylus, touch screen interface, or other known input mechanisms) for facilitating interaction of a user with the system via user interface 16. As illustrated, user interface 16 may be directly coupled to IA server 10/MON server 11, or indirectly coupled to IA server 10/MON server 11 through one or more interfacing modules (e.g., network server IS) and one or more direct or indirect transmission paths (e.g., symbolically represented as “network 17”).

Network 17 may take any wired/wireless form of known connective technology (e.g., corporate or individual LAN, enterprise WAN, intranet, Internet, Virtual Private Network (VPN), combinations of network systems, etc.) to allow IA server 10 and/or MON server 11 to provide local/remote information and control data to/from other locations (e.g., remote database server 18/remote database 19, network server 15/user interface 16, etc.). In accordance with a preferred embodiment of the invention, IA server 10 and/or MON server 11 may be implemented in stand-alone or network devices, as well as serving one or more users over a collection of remote and disparate networks (e.g., Internet, intranet, VPN, etc.).

In accordance with a preferred embodiment of the invention, information related to behavioral health issues is stored in database 12 and/or in one or more remote database systems (e.g., database 19). (For simplicity, reference is made herein only to database 12, although it should be readily apparent that one or more supplementary or alternative storage devices (e.g., remote database 19) may be employed in lieu of (or combination with database 12) for any given implementation of the invention.) Database contents (e.g., data sets stored in database 12) are accessible by any authorized component of the system (e.g., IA server 10, MON server 11, report server 13, learning center 14, user 16, etc.).

In this exemplary embodiment, the behavioral health information stored is related to various behavioral health issues such as Attention Deficit/Hyperactivity Disorder (ADHD) and other learning difficulties, including specific information (e.g., Behavioral Health Record (BHR), treatments, medications, interventions, scales, tests, screens, guidelines, checklists, etc.) related to individual or groups of patients, clinicians (e.g., doctors, psychiatrists, psychologists, specialists, etc.), schools, teachers, parents, and other caregivers, as well as government-related information (e.g., records, notices, laws such as the IDEA, regulations, guidelines such as the American Academy of Pediatrics guidelines for ADHD, etc.). Generalized information (e.g., explanatory material, (on-line/off-line) publications, papers, lists of/links to other resources and information related to behavioral health issues (or other chronic diseases), etc.) may also be stored in addition to (or in lieu of) such information found in learning center server 14.

The behavioral health information may be stored as a continuous set of data segmented to form a contiguous whole, or separated into different segments to reside in and among one or more (local or remote) server databases, as well as partitioned for storage in one or more (local or remote) files to achieve efficiencies in storage, access, and processing of data. The stored behavioral disorder information may be stored in one or more database structures for use in their raw, natural, or unmodified data states (e.g., as delivered from the data source). In accordance with a preferred embodiment, at least some portion of the information (or the input mechanisms themselves) may be modified prior to data storage in database 12 to provide a single, comprehensive standardized set of data. For example, some or all system inputs, including assessment ratings, diagnosis, treatment plans, outcomes measurements, etc. may be standardized to allow creation of a large standardized database useful to compare treatment and outcomes for a given assessment/diagnosis profile, or as a research platform for testing of new screening tools or treatment protocols.

In accordance with a preferred embodiment of the invention, IA server 10 facilitates the initial assessment of behavioral health disorders and learning difficulties and the establishment of a baseline patient treatment. During an initial assessment, inputs from a plurality of users (e.g., clinician, patient, caregivers, etc.) through interfaces 16 are received and processed by IA server 10. In accordance with a preferred embodiment, assessment module 104 (alone or in conjunction with other modules) is programmed to populate a behavioral health record (BHR) for one or more of the patients to be assessed. The BHR may include patient information, family information, school history, review of systems, medical history, birth history, delivery, development history, lead exposure, stress factors, family history, and any other information deemed necessary for completing an initial assessment of a patient. Preferably, the information is input through user interface 16 from one or more persons, groups, or entities (e.g., parent, teacher, physician, health management organization (HMO), hospital, school, spouse, company, etc.) most knowledgeable for the information required in the BHR. Assessment module 104, for example, may be programmed to provide an interactive information gathering session (e.g., on-line questionnaire, wizard-type interview session, etc.) with one or more users through (local/remote) interface 16 by providing output for display to and response by the user. Some or all of the information, however, may also be input, retrieved, accessed, or otherwise obtained from one or more (local/remote) information systems (e.g., remote database 19).

In accordance with a preferred embodiment, assessment module 104 (alone or in conjunction with other modules) is further programmed to collect any additional information (e.g., beyond the BHR) that may need evaluation by a physician or other professional to assess a patient. Assessment module 104 may be programmed, for example, to administer the taking and completion of one or more assessment scales by individuals (e.g., parents, teachers, or other individuals or entities). The administration of the assessment scales may take the form of an interactive session with an individual, group, entity, or other evaluator through user interface 16. A series of questions (“scales”) requiring rated or scaled responses from the evaluator, for example, may be output by assessment module 104 for display on user interface 16. Where a set of scales are required to be administered to evaluate a patient for a particular issue (e.g., ADHD), assessment module 104 is programmed, in accordance with a preferred embodiment of the invention, to facilitate the administration of such scales. In particular, assessment module 104 is programmed to utilize intelligent processing (e.g., artificial intelligence processing technology, etc.) to output selected questions based on previous responses received (e.g., from the individual or others) or based on other information (e.g., BHR) obtained regarding the patient. Questions and responses that have little or no bearing on the clinician's evaluation of the particular patient can thus be eliminated so as to facilitate and expedite the assessment process for all the evaluators and systems involved. The responses obtained are then stored in a memory unit (e.g., memory 102, database 12, remote database 19, etc.) for access by other evaluators or system modules.

In accordance with a preferred embodiment, diagnostic module 105 (alone or in conjunction with other modules) is programmed to facilitate the diagnosis of one or more patients assessed through assessment module 104. A clinician may, for example, be provided access through user interface 16 to the information collected by assessment module 104 (e.g., BHR, scales provided, corresponding results obtained, etc.). Diagnostic module 105 may be programmed to provide summaries and/or perform statistical (or other analysis) on the assessments undertaken for select (or groups) of patients. Report server 13 may be utilized to generate summary or analytical reports, graphs, or other output of assessment and/or BHR information for consideration by clinicians (or others) in producing a diagnosis regarding the behavioral health condition of a patient. Diagnostic module 105 may be further programmed to record and track diagnoses provided by one or more clinicians. The diagnoses may be input by clinicians (or others) through use of a variety of mechanisms (e.g., on-/off-line diagnostic worksheets, etc.). Report server 13 may employ any number of known output technology (e.g., audio, video, e-mail, facsimile, telephonic, print, etc.) to produce the generated outputs.

In accordance with a preferred embodiment, treatment/referral module 106 (alone or in conjunction with other modules) is programmed to facilitate the entry, tracking, recording of diagnoses and treatment plans, as well as initiation of referrals made by one or more clinicians for a patient evaluated using the system. Treatment/referral module 106, for example, may be programmed to obtain additional information needed by a clinician before diagnosis can be accomplished. A clinician may desire additional tests be performed (or referred out for performance), or may seek scores or results from previously performed tests (e.g., achievement testing, cognitive testing, computer-based attention tests, state standardized achievement test, supplemental tests, etc.). Where needed, treatment/referral module 106 searches for, retrieves, accesses, or otherwise contacts other sources (e.g., clinicians, schools, laboratories, hospitals, etc.) to attempt to obtain the needed information.

Treatment/referral module 106 may be programmed to facilitate the referral to others of the patient for further testing or treatment. Treatment/referral module 106, for example, may retrieve and output a list of referral sites (e.g., other clinicians, hospitals, laboratories, etc.) and any corresponding information (e.g., name, address, specialty, etc.). Treatment/referral module 106 may be used to track and record (e.g., using an on-/off-line worksheet) the referral information in memory (e.g., memory unit 102, database 12, etc.) for subsequent access by the clinician (or others) seeking a history of past referrals. Similar tracking and recording of a medication or other treatment plan (e.g., using an on-/off-line medication worksheet) may be performed by treatment/referral module 106. Reports (or other outputs) of the treatment plans, referrals made, scores or testing, etc. may be generated by report server 13.

In accordance with a preferred embodiment, report server 13 (alone or in conjunction with other modules) provides reports (or other outputs) to clinicians (and others) having authorized access to a patient's records. Report server 13 may be a processor or processor-based subsystem that executes one or more program instructions stored in (local/remote) memory. Reports can be customized such that an authorized requester (e.g., clinician) can specify the report elements and format for compiling individual or automatically generated reports of select reference items or comprehensive summaries of patient records. Report server 13 (alone or in conjunction with other modules) may further provide authorized users (e.g., clinicians) to record their clinical findings and recommendations so that each member of a patients care team may have access to all other findings and recommendations. Report server 13 also logs treatment notes that may be recorded by individual care team members in evaluating or diagnosing a patient.

In accordance with a preferred embodiment, learning center server 14 (alone or in conjunction with other modules) is programmed to assist the user in gathering information about behavioral health issues generally, and the use of the system in particular (e.g., help files, feedback channels, etc.). Learning center server 14 is a processor or processor-based subsystem that stores, retrieves, access, or otherwise makes reference to (e.g., providing a hyperlink or otherwise identifying a location of) resources that may be useful in educating or informing users of various aspects of behavioral health issues. The learning center server 14, for example, may function as a virtual library on behavioral health issues, facilitating the downloading or other access to relevant documents, publications, studies, published test results, guidelines, laws, regulations, FAQs, links to Web resources, lists of books and journals, etc.

In accordance with a preferred embodiment of the invention, MON server 11 facilitates the monitoring of a patient diagnosed with a behavioral health disorder or learning difficulty (e.g., ADHD). Preferably, the patient has been assessed and diagnosed utilizing IA server 10, in the manner described above. In accordance with a preferred embodiment, patient tracker module 113 (alone or in conjunction with other modules) is programmed to allow all authorized care team members (e.g., parents, spouses, teachers, schools, clinicians, HMOs, etc.) to gain access to patient records and information through user interface 16, including BHR, assessments, diagnoses, medications, treatments, referrals, additional testing, notes, etc. as obtained by IA server 10. Patient tracker module 113 may be programmed to operate as a search engine to retrieve or access patient files or records, individually (e.g., by patient), grouped together (e.g., by practice or clinician), or categorized (e.g., undiagnosed, diagnosed, member, etc.).

In accordance with a preferred embodiment, patient home page module 114 (alone or in conjunction with other modules) is programmed to generate and update a patient home page resident on MON server 11 (or other capable server subsystem) for use by a patient, the patient's parents, or other caregivers to monitor the condition of the patient. The patient home page may be provided to inform interested users of any treatments being entered, corresponding order, and any other current relevant information (e.g., current prescribed medications). Information (e.g., order date, instructions, status, results, etc.) on assessments that have been authorized by the patient's clinician(s) can be accessed through the patient home page.

In accordance with a preferred embodiment, assessment tool module 115 (alone or in conjunction with other modules) is programmed to provide ready access to authorized users of pertinent assessment information. Assessment tool module 115 provides access to parents, for example, of authorized assessments, completed assessments, expired assessments, and the BHR. As part of (or in conjunction with) assessment tool module 115, an assessment planner is effectuated to give users (e.g., parents) the opportunity to “order” assessments for themselves and the patient's teacher. The users are able to specify when and how often, for example, the teacher is required to supply the necessary progress information. In addition, the user is given access to the output of this supplied information and is therefore able to better track and gage the interventions effectiveness. This encourages parent and teacher cooperation and input.

In accordance with a preferred embodiment, medication tracking module 116 (alone or in conjunction with other modules) is programmed to receive and track prescribed medications entered by a clinician (or others). Using medication tracking module 116, a clinician is permitted to change prescriptions and dosage information at any time, as required. Medication tracking module 116 permits access to the medication history of a given patient to authorized users via user interface 16.

In accordance with a preferred embodiment, authorized assessment module 117 (alone or in conjunction with other modules) is programmed to receive instructions from a clinician (or others) to order assessments to be taken by specified evaluators (e.g., parent, teacher, etc.) as deemed required (e.g., for titration, for monitoring, etc.). Assessments may be ordered based on a patient's current treatment, as provided by MON server 11. A clinician can order tests into the future and schedule when a specified evaluator is to take each assessment based on, for example, need, treatment plan, next consultation. Authorized assessment module 117, a clinician can go in to any authorized assessment at any point and monitor progress by viewing output of the assessment results. Based on their findings, clinicians are permitted to adjust all treatments as necessary.

In accordance with a preferred embodiment, behavioral intervention module 118 (alone or in conjunction with other modules) is programmed to provide information and access to the most common and effective behavioral interventions used in treating a particular learning difficulty or behavioral disorder (e.g., ADHD). Having assessed a patient, and diagnosed a behavioral disorder, a clinician is able to target a behavior and be provided with choices of the most effective interventions (e.g., tutoring, counseling, etc.). In accordance with a preferred embodiment, behaviors may be targeted by users (e.g., parents) who have a desire to choose a specific area to target. In this case, behavioral intervention module 118 is programmed to permit the user to choose an intervention associated with that target area, and view past interventions. The targeted area and/or chosen intervention, once entered by the user, can be shown on the graphical output the clinician generates so as to make the clinician aware of the user's (e.g., parent's) “treatment” plans. In accordance with a preferred embodiment, alternative therapies or “treatments” may be suggested and explained to users through behavioral intervention module 118. In this illustrated embodiment, explanations why the therapies are considered “alternative” or controversial are provided. User's electing to implement such alternative therapies can track and record progress through behavioral intervention module 118 (or other modules).

In accordance with a preferred embodiment, trending module 120 (alone or in conjunction with other modules) is programmed to provide statistical (or other analysis) of assessment results taking into account all other information regarding a patient. Clinician's using trending module 120 are provided with the opportunity to view trend graphs of assessment results in any desirable form (e.g., (local/remote) display, print, e-mail, facsimile, hard copy, etc.). By providing information from each evaluator of a patient in graphical form, for example, clinicians (or others) can easily see comparisons and patterns in assessment data. Trends in other information (e.g., interventions used based on the time frame, significant life events having affect on patient, etc.) may also be viewed.

In accordance with a preferred embodiment, report server 13 forms an integrated report writer that is capable of reporting all the information gathered by the system. Report server 13 is programmed to prepare reports in a format that is organized and fully documents the assessment procedure as required by government, school, and insurance entities. In accordance with a preferred embodiment, all members of a patient's care team are allowed to document their respective findings and report them in a single, easy-to-read format. Any number of variations of the report may be generated, as report server 13 is programmed to permit any authorized user to customize a report to generate only select information as desired for the user.

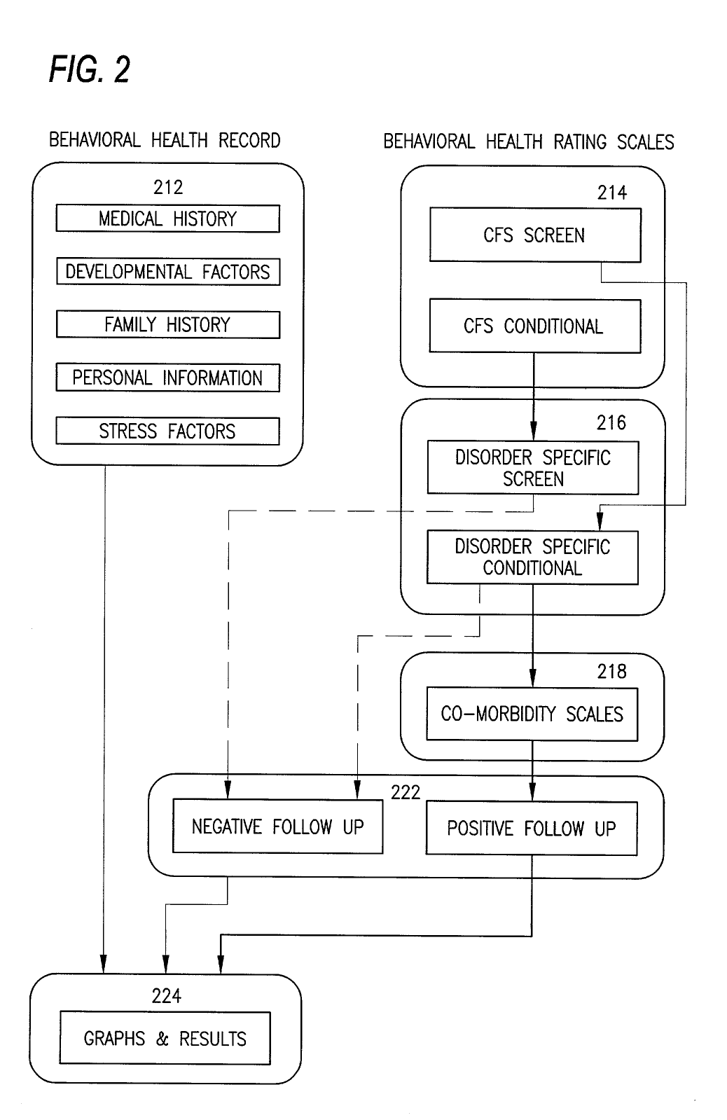

A method derived from the use of one or more of the exemplary embodiments described above is illustrated in FIG. 2. The exemplary method is implemented to assist behavioral health assessment and treatment planning, in accordance with a preferred embodiment of the invention. As illustrated in FIG. 2, a question and information flow is presented in which patient information is collected and analyzed in light of desired behavioral rating scale information (e.g., behavioral health). Patient data is first collected in a record keeping branch (e.g., the Behavioral Health Record (BHR) branch 212). Preferably, the medical consumer is presented a series of questions about the patient's medical history, family history, developmental factors, and other pertinent information. The answers given to these questions are stored in the patient database for contextual diagnosis support. Second, the patient is presented a series of questions comprising several relevant rating scales (e.g., behavioral scales such as the Child Functioning Scales (CFS) in CFS branch 214, the Disorder-Specific Scales (DSS) in Single-Disorder branch 216, and Multi-Disorder Scales (MDS) in Multi-Disorder Scales branch 218).

This exemplary method embodiment of the invention allows the several scales to share and dynamically adapt to response information across scales, resulting in a significant savings of time and effort for the patient and/or the system user. Duplicate questions are eliminated, as well as irrelevant or inapplicable questions, resulting in a more effective information flow.

After all necessary questions have been answered, the information is stored for future reference, for example, during follow-up reporting and assessment in the Follow-Up branch 222, as shown in FIG. 2. Present and past reporting results are automatically combined with other medical database information in the system output and summary graphs and raw data (response data) are produced in the Graphs and Results branch 224. Among the output of the Graphs and Results branch 224 may be a single-page graphical summary of scoring information known as a SNAPSHOT. The SNAPSHOT assists physicians in making a preliminary diagnosis quickly by providing the most relevant information in an easy-to-read format.

The output of the Graphs and Results branch 224 is intended to give the patient's physician indications of problem areas to help direct the interview with the patient. Interview forms, customized for the indicated areas of dysfunction, may be provided with generic questions that may be chosen for use by the physician. These forms may help facilitate a differential diagnosis by the patient's physician, including checks of physical or neurological problems that could cause behavior that mimics specific disorders. Diagnosis information can also be recorded in system databases to track outcomes. In this way, the preferred embodiment of the invention helps the physician avoid incorrect diagnoses and run a more efficient and effective practice.

The illustrated embodiments may be used in multiple locations by multiple evaluators for assessment, monitoring, and reporting purposes. Standardization of the input and system databases, if used, allows a variety of different evaluators, such as parents, teachers, general practitioners, and specialists, to make use of system information and assist the patient in assessment and reporting activities. The embodiments may also provide increased flexibility to track time- and context-dependent disorder indications to help facilitate, for example, behavioral disorder diagnosis, treatment, monitoring, and reporting.

Additional input and output information may also be integrated into the exemplary information flow described above. For example, SPECT SCAN information gathered at a remote location for any patient may be linked into the patient database for consideration during diagnosis, treatment, monitoring, and reporting by the patient's physician. Also, insurance coverage codes and other claims-related information, as well as prescription information, may be input or output using embodiments of the invention. In accordance with a preferred embodiment, an off-line research database may be provided containing patient data (from the system central database) stripped of any personal identification. This comprehensive data can be accessed, exported, or the like for research purposes by institutions and other interested parties. The data may also be available to subscribers in various forms (e.g., summary) as a reference, for diagnosing and treatment decision making, as well as for reporting processes.

### EXAMPLE

As an illustration of a commercial embodiment of the invention, one implementation of the invention in a Web site, “www.PortMD.com,” is provided below (and described in more detail in the three aforementioned U.S. Provisional Applications identified above, including their respective Appendices, which are incorporated herein by reference in their entireties).

### The PortMD System

PortMD

PortMD has a unique interactive medical resource provision technology that facilitates diagnosis, treatment planning, monitoring, and reporting for behavioral health assessment. When packaged in a network-based environment, as shown, for example, in FIG. 2, this resource provision technology eases the process of obtaining medical assistance using a networked computer. By allowing all members of the care team to work together and share information.

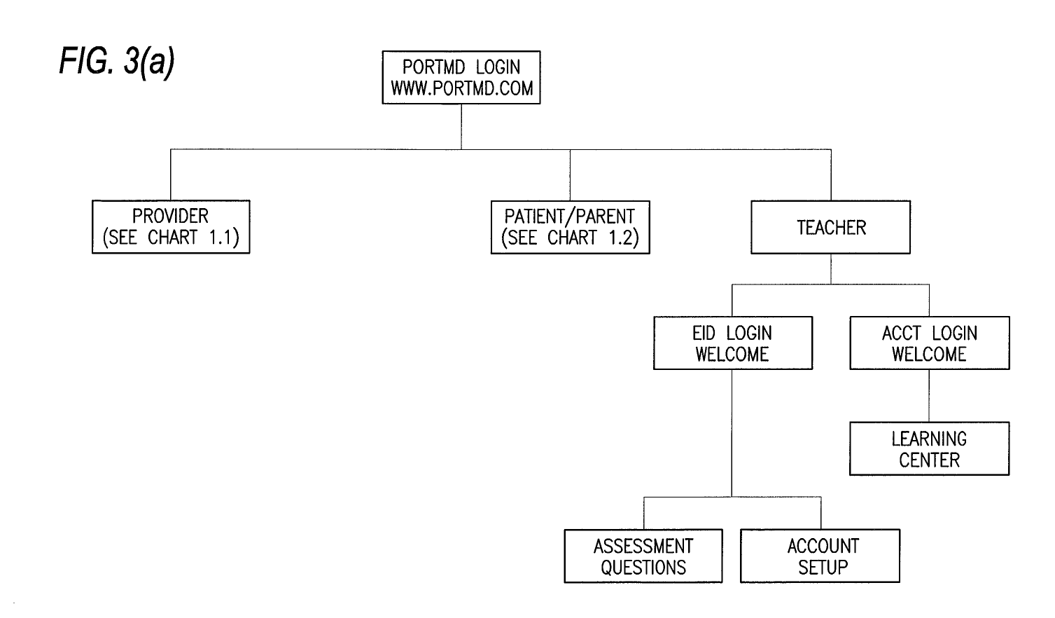

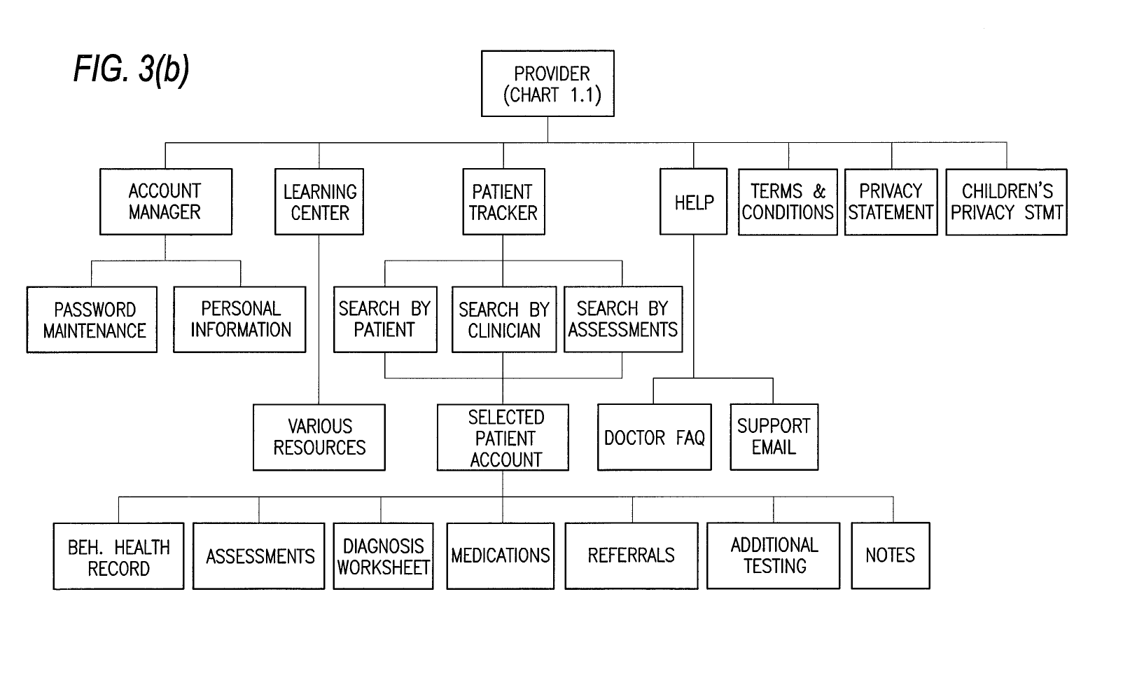

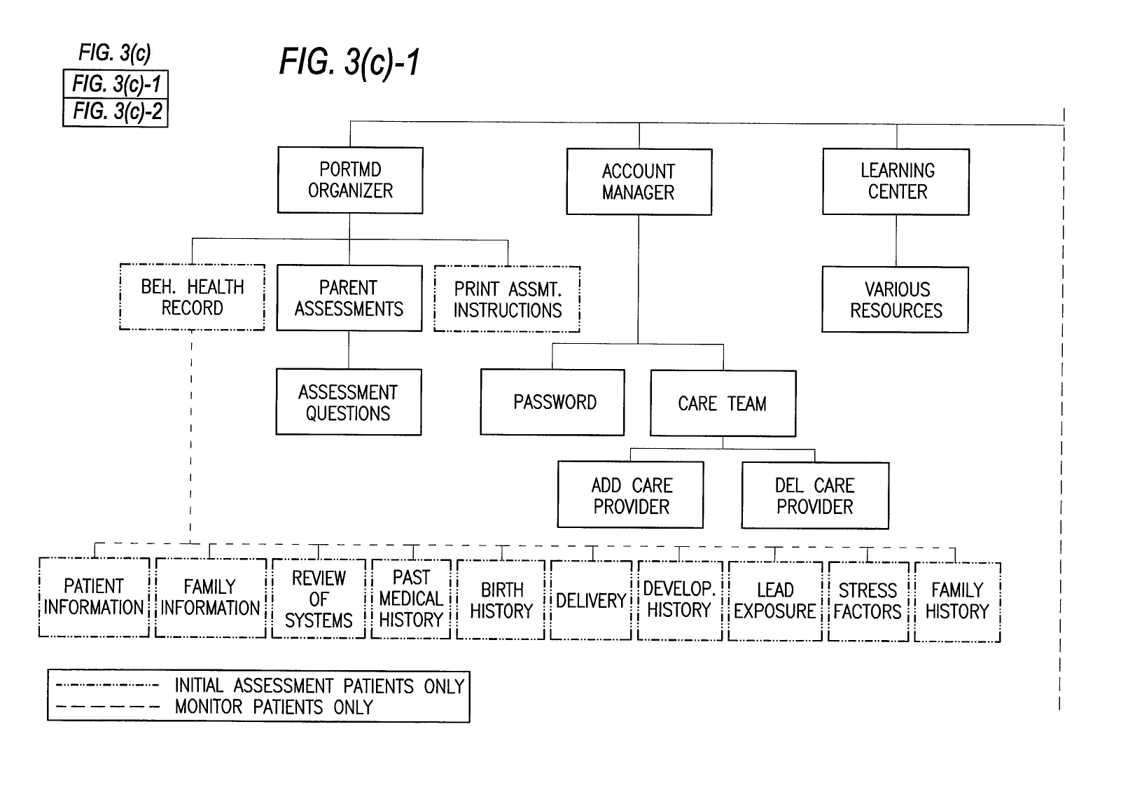

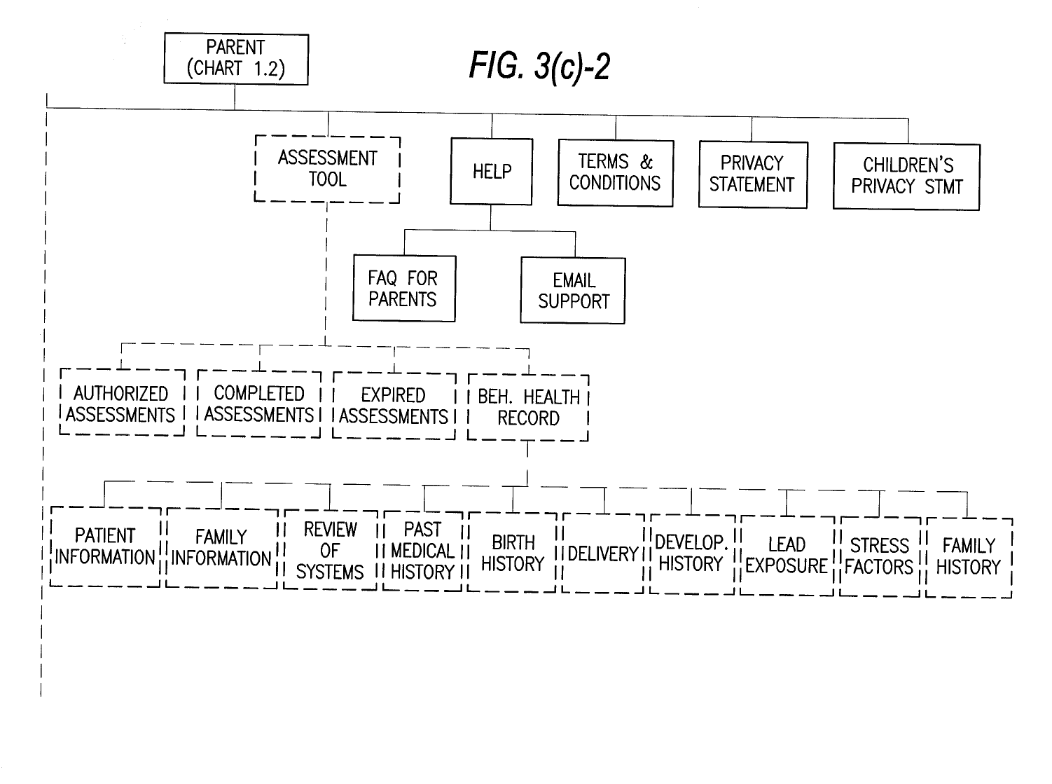

The PortMD technology provides a network environment in which doctors, patients, psychologists, mental health professionals, educators and other interested persons or parties may interact for the purpose of facilitating the diagnosis, treatment, monitoring, and reporting of behavioral health problems. PortMD may provide clinicians with medical news and scientific/technical reports on issues facing behavioral health care providers, a forum for discussion of related issues with other clinicians as well as patients, a directory for contacting doctors, patients and others, and patient tracking, monitoring, and reporting services for managing medical history information and authorizing the provision of medical services. An exemplary operation of the PortMD technology is illustrated in FIG. 3. In providing such an environment, PortMD facilitates communication among clinicians, patients, educators and others, helping all interested persons and parties to become better informed and easing common problems faced in the practice of behavioral medicine and therapy.

The PortMD environment may include the following participants:

PortMD—enabling technology, application hosting, customer service, database management, patient monitoring, and reporting.

Suppliers—sources of technical, patient, and outcomes database information.

Consumers—end users accessing the resources supplied by Suppliers and PortMD.

The Enabling Technologies of the PortMD System

PortMD may provide a Web site with a home page and five major modules, including:

(1) Learning Center

(2) Help Center

(3) Account Manager

(4) Patient Tracker,

a. Monitor and assessment module

b. Report Writer module

The home page of the PortMD system provides a linking module for off-site resources to access all other modules, as well as display general system news and information. Each major module is described below.

### Learning Center

The Learning Center module is the location of general medical information collected and categorized for ease of access by medical information consumers. Selected information appears in a Medical News w/Links sub-module and a Medical Abstracts w/Links sub-module, including late-breaking developments and scientific information in the various fields relating to Behavioral Health and learning difficulties. Sub-modules are also available to identify information geared toward the medical professional vs. the patient. Also available are classroom strategies and suggestions on how to better communicate with teachers and parents.

The Discussion Forums module contains threaded discussions of various topics relevant to Behavioral medicine. Discussions are segregated into Clinician forums and Patient forums in order to permit a free exchange of ideas in a flexible environment. For clinicians, available discussions include, for example, discipline-specific topics, practice notes, implementation guidelines, and general medical topics. For Patients, discussions are available concerning, for example, parenting, patient support, and general medical topics.

### Help Center

The Help Center module assists the consumer obtain assistance from the PortMD system. Each consumer uses this module to provide identification and contact information in order to access the PortMD environment. Sub-modules include system bulletin boards on which consumers and system managers may interact, FAQs for system issues, tutorials and getting started information, structured interviews for the clinician and email and phone links for direct communication between consumers and system managers.

### Account Manager

The Account Manager module provides interactive access to secure services for system users and administrators. Available secure services include entry and maintenance of Clinician and Patient personal information, including consumer identity, medical history, professional history, and passcode data. System administrators access the Account Manager module in order to verify identity and assist consumers access the PortMD system.

### Patient Tracker

The Patient Tracker module is the location of the reporting and assessment interaction facility of the PortMD system. Clinicians may review and analyze Patient-provided information and results of their Patients' assessment tests, authorize further assessments, and enter and modify diagnosis or treatment recommendations.

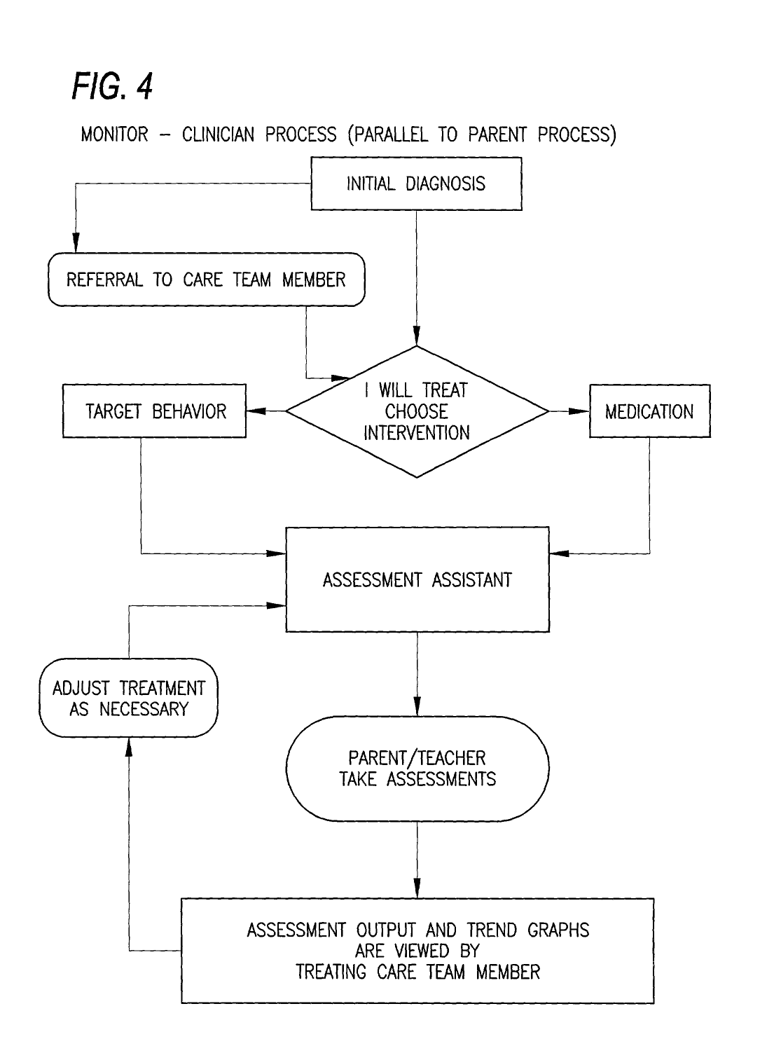

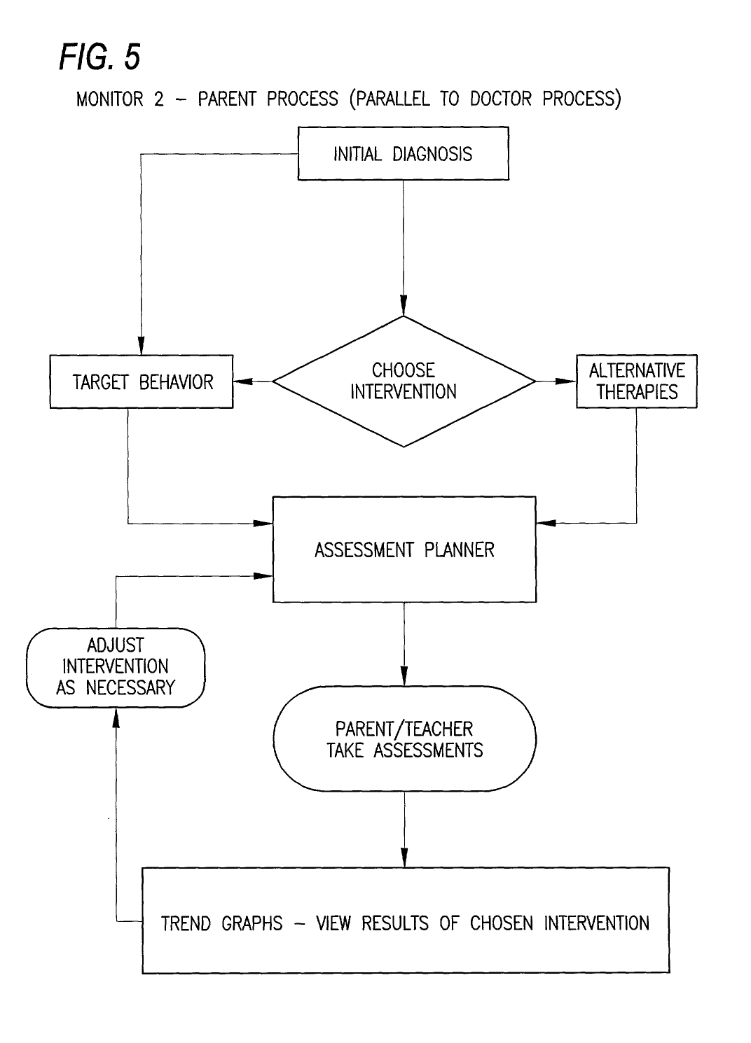

The Monitor module allows patients, parents, clinicians, educators, and others who are authorized members to monitor the effectiveness and adjust treatment as necessary. The Monitor module, for example, focuses on titrating prescribed medication, ordering and tracking interventions, permit taking and review of assessments, and facilitating parental management of a child's disorder. An exemplary operation of the Monitor module is depicted in FIGS. 4 and 5.

The Integrated Report Writer module allows gathering of information from all members of the care team (e.g., psychologists, school administrators, teachers, pediatricians, etc.), whether or not the members provide information through the PortMD system. The information may be gathered and presented in whole or part into a comprehensive report, encompassing input and documentation from the various members and other sources. The comprehensive report is all-encompassing, organized to fully document the assessment procedure as required by government, school, and insurance agencies.

The integrated report writer may be provided, for example, for use after initial screening and treatment to assess the accuracy of diagnosis and monitor the effectiveness of different courses of treatment. The report writer allows the gathering, evaluating, and composing of information through the system for report generation through selection of desired components and outputting (e.g., printing) reports.

The PortMD system also includes standardized formats for data input and storage, permitting the development of comprehensive databases of medical information, including patient, disorder, treatment, and outcome data. By combining information from databases containing all major diagnoses, age and gender groups, the PortMD system can provide multi-disciplinary statistical information for improved diagnosis support. In addition, an artificial intelligence monitor continuously assesses system performance to streamline reporting and data analysis.

### Participants in the PortMD System

PortMD

PortMD plays the central role in the gathering, organization and dissemination of medical resources available on the PortMD Web site. PortMD database development combined with application development and deployment ensures the steady supply of Internet-deployed medical information to Doctor, psychologists, schools and Patient consumers.

PortMD maintains the Discussion Forum online community as a virtual meeting place for Clinicians and Patients seeking medical information and assistance. Site features including chat, forums, polling and discussions create and foster an open dialog.

PortMD also maintains the online databases of patient, clinician, diagnosis, treatment and outcomes information. PortMD collects information of interest to Clinicians and Patients in the medical news sub-modules of the Learning Center, and provides links to other relevant online information.

PortMD provides the interactive reporting and assessment environment of the Patient Tracker module to facilitate the gathering of information from the Patient and analysis of that information by treating Clinicians. By combining statistical comparison data, treatment data, and outcome data with patient scoring on disorder-specific scales, Clinicians and Patients are provided with improved diagnosis and treatment planning.

PortMD maintains (or controls) its own (or third party) servers and is therefore able to host and provide support for any medical consumer with access to the Internet. Maintaining the hosting infrastructure ensures that resources can be deployed immediately and with nearly 100% reliability.

### Suppliers

Medical information suppliers provide the medical resources available to Consumers through the PortMD environment. For example, medical news and abstracts may be made available to Clinicians and Patients by linking to one of the plethora of online medical magazines or scientific journals available on the Internet. If fee-for-access information is included, PortMD could share electronic payment information with Suppliers upon consumer request. This wealth of information can further enhance the collaborative effort by physicians and their “Care Team” in assessing and treating patients.

### Consumers

Medical information consumers, including Clinicians and Patients, access the resources provided by the Suppliers through the PortMD system. For example, a Patient seeking medical information and assistance concerning a specific behavior problem could access the Learning Center to obtain information on several aspects of the problem, the Discussion Forum to share experiences with other Patients, and the Assessment Tool to take an online assessment test for the disorder. A Clinician who specializes in the field of the Patient's behavior disorder could access the Learning Center to check on recent developments, access the Discussion Forum to learn how other Clinicians approach their practice, and review the Patient's assessment test results in order to develop a suitable treatment plan.

While preferred embodiments of the invention have been described and illustrated, it should be apparent that many modifications to the embodiments and implementations of the invention can be made without departing from the spirit or scope of the invention. For example, while only a method of (and the corresponding apparatus for) providing health services for behavioral health disorders and learning difficulties in the form of ADHD has been particularly described, it should be readily apparent that the invention may be embodied in any type of diagnosis or other treatment planning mechanism for behavioral health issues (or other chronic diseases) that lends itself to online exchange of medical information (e.g., Attention Deficit Disorder (ADD), Hyperactivity Disorder (HD), Oppositional-Defiant Disorder (ODD), Conduct Disorder (CD), depression, anxiety, and others defined in the Diagnostic and Statistical Manual (DSM-IV)). Also, although the embodiments disclosed have been specifically illustrated as applied to the Internet, the invention may easily be deployed on any network system, intranet, local or wide area network, or other communication system.

While a client-server architecture has been specifically illustrated herein, the invention may easily be deployed in any form of network or communication technology. While the illustrated embodiments have not specified the type of communication medium (or protocol) used to connect the various modules (e.g., shown in FIG. 1), it should be apparent that any known wired/wireless technology may be used to implement the invention (e.g., Internet, intranets, private bulletin boards, individual local or wide area networks, proprietary chat rooms, ICQ, IRC channels, instant messaging systems, WAP, bluetooth, etc.) using real-time or non-real-time systems alone or in combination. The embodiments described in (or apparent from) the instant disclosure may be employed in stand-alone (or network linked) systems. The embodiments may similarly be implemented in other known systems and platforms (e.g., personal computer, Internet-based devices, PDAs, portable or hand-held electronic devices, etc.).

In accordance with a preferred embodiment, one or more user interfaces (e.g., user interface 16 (FIG. 1)) are provided as part of (or in conjunction with) the illustrated systems to permit users to interact with the systems. User interface devices may be any device used to input and/or output information. The user interface device may be implemented as a graphical user interface (GUI) containing a display or the like, or may be a link to other user input/output devices known in the art. Individual ones of a plurality of devices (e.g., network/stand-alone computers, personal digital assistants (PDAs), WebTV (or other Internet-only) terminals, set-top boxes, cellular/PCS phones, screenphones, pagers, kiosks, or other known (wired or wireless) communication devices, etc.) may similarly be used to execute one or more computer programs (e.g., universal Internet browser programs, dedicated interface programs, etc.) to allow users to interface with the systems in the manner described. User interfaces 16 may be used to download records for local use by the user (e.g., by clinician's for consultation with patients). Any revisions, additions, annotations, or other changes to the data in the records can be uploaded and synchronized with the records resident in the system (e.g., in database 12), if the user is authorized to make such changes to the records for storage in the system. One or more control modules or components (e.g., report server 13) is preferably programmed to control such downloading, uploading, synchronization of records through user interfaces 16.

The modules described herein, particularly those illustrated or inherent in the instant disclosure, may be one or more hardware, software, or hybrid components residing in (or distributed among) one or more local or remote computer systems. Although the modules may be shown or described herein as physically separated components (e.g., assessment module 104, diagnostic module 105, IA server 10, MON server 11, etc.), it should be readily apparent that the modules as described herein may be merely logical constructs that are implemented as physical components combined or further separated into a variety of different components, sharing different resources (including processing units, memory, clock devices, software routines, etc.) as required for the particular implementation of the embodiments disclosed herein. Indeed, even a single general purpose computer (or other processor-controlled device) executing a program stored on an article of manufacture (e.g., recording medium or other memory unit) to produce the functionality referred to herein may be utilized to implement the illustrated embodiments.

In addition, memory or database units described herein may be any one or more of the known storage devices or systems (e.g., Random Access Memory (RAM), Read Only Memory (ROM), hard disk drive (HDD), floppy drive, zip drive, compact disk-ROM, DVD, bubble memory, redundant array of independent disks (RAID), network accessible storage (NAS) systems, etc.), may also be one or more memory devices embedded within a CPU, or shared with one or more of the other components, and may be deployed locally or remotely relative to one or more components interacting with the memory or database units.

Although not specifically mentioned, it should be readily apparent that IA server 10 (and other modules) described herein as accessing database 12 (or other remote database systems) may further include or be used in conjunction with search technology (e.g., spiders, worms, bots, or other known devices) used to access information in remote database systems (or other memory unit) over any internal or external network (e.g., the Internet) to perform the various functions of retrieving, accessing, searching, etc. for stored information.

The illustrated embodiments have further been described in connection with user 16. For simplicity, the description of the interaction between user 16 any of the system modules (e.g., IA server 10) may have expressly or impliedly referenced a direct connection to such modules. It should be readily apparent, however, that the same functions, operations, or capabilities to interact with the described modules exist for indirectly connected user interface 16 (e.g., those connected through network server 15 and network 17, as shown in FIG. 1). Moreover, it should be readily apparent that a “user” of the various aspects of the inventive systems or methods disclosed herein may be individuals, entities, devices, as well as peer/non-peer systems or technologies, and modules within the same device (e.g., IA server 10) or system without departing from the scope of the invention.

Accordingly, the invention is not to be limited by the foregoing description or drawings, and only by the claims appended hereto.

What is claimed is:

1. A method for facilitating behavioral assessments and monitoring mental health patients over a computer network, comprising:
receiving a subject's personal information and behavior-related medical;
storing said personal information and behavior-related medical history in a computer storage medium;
selecting general behavioral assessment questions based upon said personal information and behavior-related medical history;
outputting said general behavioral assessment questions for prompting general responses by persons having knowledge of said subject's behavior;
receiving and storing responses said general responses;
selecting and outputting disorder specific behavioral assessment questions for prompting specific responses by said persons;
receiving and storing said specific; and
outputting diagnostic behavioral assessment information based on said general and specific responses.

2. The method of claim 1, further comprising receiving and storing payment information to the storage medium.

3. The method of claim 1, further comprising storing and outputting said subject's medication information.

4. The method of claim 1, further comprising storing and outputting articles and other information related to said subject's disorder.

5. The method of claim 1, further comprising receiving, storing and outputting referring medical provider information.

6. The method of claim 1, further comprising receiving, storing, outputting subject-to-subject messages in a patient message forum.

7. The method of claim 1, further comprising receiving behavioral disorder or learning difficulty information search requests, and searching for, retrieving and outputting said behavioral disorder or learning difficulty information.

8. The method of claim 1, further comprising an assessment tool.

9. The method of claim 8, wherein said assessment tool permits parents to access authorized assessments, completed assessments, expired assessments, and a behavioral health record of a patient.

10. The method of claim 1, further comprising:
comparing all input requests against a list of authorized persons; and
granting or denying said input requests based upon said comparing step.

11. An information system for facilitating behavioral assessment and monitoring of patients over a computer network, comprising:
a processor; and
a storage device, said storage device including a program for controlling the processor, said program comprising:
(a) receiving and storing personal information and medical history information concerning a patient from persons with required information;
(b) outputting general behavioral assessment questions to ones of the persons with required information;
(c) receiving and storing general responses to the general behavioral assessment questions;
(d) outputting specific behavioral assessment questions based upon said personal information, medical history and general responses;
(e) receiving and storing specific responses to the specific behavioral assessment questions; and
(f) outputting diagnostic behavioral assessment information based on said personal information, medical history, general responses and specific responses.

12. The information system of claim 11, wherein the behavioral assessment questions are assessment scales administered to evaluators for treating learning disorders.

13. The information system of claim 12, wherein the assessment scales are provided to ones of the persons, including parents of the patient and teachers of the patient.

14. The information system of claim 11, wherein the program further comprises the step of accessing responses to the behavioral assessment questions by ones of the persons.

15. The information system of claim 14, wherein the ones of the persons accessing the responses to the behavioral assessment questions access the same responses over the Internet from respective remote locations.
